(19) United States
(12) Patent Application Publication
(10) Pub. No.: US 2008/0282204 A1
(43) Pub. Date: Nov. 13, 2008

(54) User Interfaces for Electronic Devices

(75) Inventor: Rafael Del Valle Lopez, Barcelona (ES)

Correspondence Address: HAYES, SOLOWAY P.C., 175 CANAL STREET, MANCHESTER, NH, 03101, US

(73) Assignee: VIDA SOFTWARE S.L., Barcelona (ES)

(21) Appl. No.: 11/817,525

(22) PCT Filed: Mar. 3, 2006
(86) PCT No.: PCT/GB06/00776

§ 371 Date: Apr. 25, 2008

(30) Foreign Application Priority Data
Mar. 4, 2005 (GB) 0504568.7

(51) Int. Cl. G06F 3/00

(52) U.S. Cl. 715/866

(57) ABSTRACT

An interaction engine (4) monitors the use of a mobile telephone (1) and applications running on the mobile telephone (1) by a user, and provides information regarding those interactions to a user expertise calculation module (7). The user expertise calculation module (7) then uses that information to determine a current level of expertise of the user of the device. The interaction engine (4) uses the determined level of user expertise to determine a set of user prompts to be used for the current user. The selected set of prompts is provided to a prompt selection module (6) of the interaction engine (4). The prompt selection engine (6) selects a prompt from the provided set of prompts based on the current status of the application or the user's interaction, which prompt is then provided by the interaction engine (4) via a speech engine (2) or visual user interface elements (3) automatically to the user.

The present invention relates to the provision and operation of user interfaces for electronic devices and in particular to user interfaces for portable or mobile devices, such as mobile telephones, personal digital assistants (PDAs), tablet PCs, in-car navigation and control systems, etc.

Electronic devices, such as mobile telephones, will typically include a so-called “user interface”, to allow a user to control the device and, e.g., input information and control commands to the device, and/or receive information from the device. For example, a mobile device such as a telephone will typically include a screen or display for providing information to a user (and possibly also for receiving user inputs, for example where a touch-screen arrangement is used), and a keypad (whether numerical, QWERTY keyboard or otherwise) for allowing a user to input commands, etc., to the device.

One difficulty with mobile devices such as mobile telephones is that the, e.g., size of their screen and keypad are constrained by the nature of the device itself, and this can and does limit and constrain the operation of the user interface provided by these features.

It is becoming increasingly common therefore to provide additional ways for a user to interact with electronic devices, in addition to a screen and keypad. For example, many mobile devices now have a so-called “speech-enabled” user interface, whereby a user may control the device using voice (spoken) commands, and the device may provide information to the user in the form of spoken text. Such speech-enabled user interfaces use, as is known in the art, automatic speech recognition and processing technology to process and respond to spoken commands provided by a user, and to allow a user to listen to spoken text (commonly referred to as text to speech synthesis (TTS) or Synthesised Text).

The addition of voice control in this manner means that in addition to a user being able to see the screen and type on the keypad, he or she can also listen to spoken text and speak commands to the device. In this way, some or all of the constraints and limitations of the screen and keypad may be alleviated or even overcome, thereby enhancing the overall user interface.

Where a user interface of an electronic device offer plural different input and output aspects or modes, such as a screen, keypad and speech as discussed above, then the user interface is typically referred to as being “multimodal” (since it provides multiple modes of user interface operation). Such multimodal user interfaces add additional modes of interaction to the user interface, which can enhance the operation of the overall user interface.

In a device having a multimodal user interface, there are typically three components that govern the operation of the device, namely an “application engine”, an “interaction engine”, and a “speech engine” (where one of the user interface modes is via speech).

The application engine executes or accesses the device applications and the underlying applications that the user wishes to use. These applications can, as is known in the art, be executed on and run on the device itself, or may, e.g., be executed elsewhere (such as on a server of the network to which the device connects), but accessible and accessed via the device. The interaction engine controls the user interface (and, e.g., is responsible for some or all of the characteristics of the user interface) and interfaces between the user interface and the device applications. The speech engine is used by the interaction engine to process and recognise speech commands and render text to speech (for output to a user).

However, even multimodal devices can still have constraints and limitations to their user interfaces. For example, in the context of a speech interface, it may not be desirable for the device to provide spoken information that is too long or to do so too frequently. Also, it may be undesirable to provide too much information in the form of spoken text, since that may compromise user privacy. Equally, a new user may need to learn what speech commands the device can accept, i.e. to learn how the speech-enabled interface operates and what it can be used to do.

It is known to provide to a user prompts, e.g., via the screen of a device or as spoken text to assist a user to use and understand the, e.g., speech interface. For example, some speech-enabled devices will, for example, provide as a spoken prompt “say, ‘help’ at any time”, to inform the user how to access the “help” function of the device. However, the extent of information that can be provided in this manner may still be limited, and users can, e.g., find it difficult to both listen to spoken text and read a screen at the same time.

The Applicants believe therefore that there remains scope for improvements to user interfaces of electronic devices and in particular to multimodal user interfaces.

According to a first aspect of the present invention, there is provided a method of operating a user interface of an electronic device, which interface may provide a plurality of prompts to a user, the method comprising:

determining a level of user expertise of a user using the device; and

providing a prompt to the user on the basis of the determined level of user expertise of the user.

According to a second aspect of the present invention, there is provided a system for providing a user interface of an electronic device, comprising:

means for determining a level of user expertise of a user using the device; and

means for providing a prompt to a user on the basis of the determined level of user expertise of the user.

According to a third aspect of the present invention, there is provided an electronic device comprising:

means for storing a plurality of prompts that may be provided to a user of the device;

means for determining a level of user expertise of a user using the device; and

means for providing a prompt to a user on the basis of the determined level of user expertise of the user.

In the present invention, a user of an electronic device may be provided with prompts to assist them in using the device, as in prior art systems. However, the prompts that are provided to the user are provided, at least in part, in accordance with a determined level of user expertise of the user. This allows the prompts provided to a user to be, e.g., better optimised to the user's knowledge and experience of, e.g., the user interface, device and/or device applications in question. It is believed that this will accordingly provide an enhanced experience and use of the device for a user.

For example, prompts relating to more basic and less complex functions and commands can be preferentially provided to users who are determined to have lower levels of user expertise and vice-versa (such that, for example, more “expert” users are provided with prompts relating to more complex functionality of the device, but are no longer provided with prompts relating to more basic functions and operations).

The prompts that may be provided to a user can be selected as desired and can, for example, relate to any appropriate matter of operation or function of the device, device applications, or user interface of the device. As will be appreciated by those skilled in the art, the prompts will and should naturally depend, for example, on the nature of the user interface, device and/or device applications, and so are preferably tailored accordingly. They may comprise, for example, commands or information that may assist a user in using the device, device applications and/or user interface of the device, and/or commands or information that relate to the operation or functionality of the device, device applications and/or user interface of the device, and/or suggestions to the user, relating, e.g., to the operation or functionality of the device, device applications and/or user interface of the device.

In a preferred embodiment the user prompts relate to, and/or comprise information relating to, functions or operation of applications that are running or that may be run on the device, functions or operations of the device itself, and/or functions or operation of the device's user interface. For example, some of the prompts could provide instructions and/or suggestions as to how to operate the device and/or its user interface. Additionally or alternatively, there could be prompts that provide information on or how to access or to use applications running on or that can be accessed by the device.

In a preferred embodiment, the prompts provide information to a user informing them of the available interaction mechanisms with the device and/or with applications running on it or accessible by it, etc. Most preferably the prompts include one or more (or preferably all) of the following categories of prompts: “welcome” prompts (e.g. “welcome to Vodafone Live portal”), generic application usage instructions or suggestions (e.g. “ask for the service you want”), application functionality tips (e.g. “check alert section for getting sports alerts”), instructions or suggestions for applications (e.g., form filling, such as “say the name of the horoscope you would like to check”), and prompts relating to interaction problems (such as “speak naturally” or “press and hold the green key to talk”, that may be provided, e.g., when interaction problems are detected).

The determined level of user expertise can be used to control the provision of prompts to a user in any desired and suitable manner. In a preferred embodiment, it is used to select the prompt, e.g., the type of prompt or actual prompt, to be provided to the user. Thus, in one preferred embodiment the method and apparatus of the present invention comprise a step of or means for selecting a prompt to provide to a user based on the determined level of user expertise.

In a particularly preferred embodiment, the determined level of user expertise is used also or instead to select or control or influence the timing of the provision of prompts that are provided to a user. For example, the frequency that prompts are provided at, and/or the intervals between (successive) prompts could be based on the determined level of user expertise (such that, for example, a less expert user receives more frequent prompts than a more expert user, and/or a user who has not interacted with the device for a given period of time is then provided with a prompt (e.g. a suggestion prompt), and/or more, and/or more frequent, prompts). Thus, in a preferred embodiment, the method and apparatus of the present invention comprise a step of or means for controlling the timing of the provision of prompts to a user based on the determined level of user expertise of the user.

In a particularly preferred embodiment, the determined level of user expertise is used to control or select both the type of prompt to be provided to a user, and the timing of the provision of prompts to a user.

In a preferred embodiment, one or more sets or groups of prompts can be provided, which sets each include, e.g., one or more predefined or predetermined prompts. For example, there could be (and, indeed, preferably is) a set of prompts relating to generic and/or low-level functions, that relate, e.g., to operation of the device and/or user interface and that are, e.g., not application dependent. A set or group of prompts could also be (and again, preferably is), e.g., defined as part of or associated with an application or applications running (or that may be run) on or accessed by the device, such that those prompts can then be selected accordingly when a user accesses that application or applications. In this case, the prompts could, e.g., be and preferably are, application specific.

Thus, in a particularly preferred embodiment, the device, and/or applications running on it or accessible by it, store or have associated with them or accessible by them, one or more (and preferably plural) sets of predefined or predetermined prompts, from which the prompt to use in use may be selected.

Where such sets of prompts are used, then the determined user expertise level is preferably used to select the set of prompts to be used (and from which the actual prompt to be used may then be selected).

It should be noted here that the prompts to be provided by a user are to provide information to the user as to, e.g., how to use or interact with the device and/or its applications, etc., and so relate, e.g., to matters of control of the device and its applications, and should therefore be contrasted with, e.g., a voice call that may be provided to the user.

The prompts should also typically be, and indeed, preferably are, provided automatically to the user. They are also preferably provided in an unsolicited manner (i.e. such that the prompts are provided by the system automatically and spontaneously (e.g. when a particular prompt “triggering” condition or criteria is met), rather than, e.g., needing a request by a user to trigger the prompt). It would also, e.g., be possible to provide some prompts in response to user requests, with other prompts being provided spontaneously by the system when the appropriate circumstances for the prompt are met.

The user prompts may be provided to a user in any desired and suitable form, for example depending upon the nature of the user interface itself, and/or that the device can support. Where the device includes a speech interface, some or all of the user prompts are preferably provided as spoken information. Other output modes, such as text on a screen or display, could also or instead be used, if desired. For example, depending on the nature of the prompt, it may be preferable to provide it in a spoken form or to display it on a screen. Preferably the different modes of the user interface are used in a complementary manner to provide the prompts.

The level of user expertise of a user can be determined in any appropriate and desired manner. It is preferably a measure of the expertise of the user in interacting with and using the device, and/or applications that are running on or that can be accessed by the device, preferably via the device's, or one of the device's modes, of user interface. Thus, the user's level of expertise in using and/or interacting with the device, device application or applications, and/or user interface is preferably determined.

Most preferably this determination includes an assessment of the relative complexity of the interactions that the user makes, and/or an assessment of the relative proportion of the available, e.g., functionality of the device and/or application, that the user uses. Both of these things will provide an indication of whether a user is more or less “expert”.

Thus, for example, in a preferred embodiment the level of user expertise is based on how expert the user is in using the interaction means provided by the device (e.g., how to talk, when to talk, how to speak, what key to press, etc.). This would provide an assessment of the user's expertise in using more “basic” functions of the device. The level of user expertise is preferably also or instead based on an assessment of how a user interacts, etc., with an application of the device or accessible by the device (e.g. whether they know what can be said to control the application itself). This may provide, e.g., an assessment of the user's expertise at a more advanced level.

In a particularly preferred embodiment, the use of the user interface, application, and/or device by the user is monitored, and then used to determine a level of expertise for the user. Most preferably the commands (e.g. speech commands) and functions that the user is using are monitored and assessed for this purpose. For example, the use of a more complex command by a user, or of a, e.g., speech command as against a typed command, could be used to rate that user as having a higher level of expertise. In a preferred embodiment, the pattern of the user's usage and/or interactions is monitored and assessed to determine their level of user expertise.

In a particularly preferred embodiment, each user interaction (e.g. with the user interface, device and/or application) is rated, e.g. by allocating it a particular numerical value or score, and the interaction rating then used to determine the level of user expertise. Preferably, the ratings (e.g. scores) of a selected number of user interactions (e.g. 5) are used in combination for this purpose. For example, the cumulative score of a selected or predetermined number of the immediately preceding user interactions (e.g. the last five user interactions) could be used to determine the level of user expertise. Preferably an average user-interaction rating or score is determined, for example taken over the last five (or other predetermined or selected number) of user interactions and/or taken over a given, e.g. predetermined, time period (e.g. in the last 5 or 10 minutes). Most preferably a moving average of the user interaction rating determined in this manner is maintained.

Other parameters for determining user expertise could also or instead be used. For example, it is preferred to also use a measure of the time (and preferably the average time) taken between user interactions when determining the level of user expertise.

In the case of a speech interface, it would also be possible (and, indeed, this is preferably done) to use, e.g., a “confidence value” determined by the speech recognition engine as or as part of the determination of the level of user expertise. (As is known in the art, a speech engine will typically determine a parameter commonly referred to as a “confidence value” that is a measure of how “confident” the speech engine is of its recognition of a user's spoken command. This confidence value can be used as a parameter for assessing the user's interactions.) Similarly, a wave analysis of the user's speech could be used as a measure of their user expertise.

It would also be possible, e.g., to monitor a user's keyboard interactions, e.g., to measure their keyboard usage patterns, and to use that as or as part of the user expertise determination.

In a preferred embodiment, plural different techniques are used to assess the user's level of expertise, and the overall determined level of expertise is determined based on a combination of the individual assessments. Most preferably a weighted combination of the individual assessments is used.

In a preferred embodiment, the current level of expertise of a given user is stored by the device, e.g., for retrieval when the user next uses the device, so as to avoid a user returning to a lower level of expertise when they next use the device.

In a particularly preferred embodiment, a user can also be allocated a “default” user expertise level. This could be used, e.g., where a new or unknown user is encountered (e.g. a user that does not have a previously stored user expertise level).

The default value of user expertise could, e.g., comprise a single predetermined value, or there could, e.g., be a range of such values to be selected based on, e.g., a previously determined user profile. It preferably sets the user expertise level to a low, e.g., the lowest value, to allow, e.g., for completely inexperienced users. Using such a default value allows the system to handle “unknown” user situations.

Thus, in a preferred embodiment, the system can identify whether a user is new or “unknown” (e.g. based on whether they have an already stored user expertise level), and when such a user is identified, can allocate to such a user a default user expertise value.

Where the user prompt that is provided to a user is to be selected in response to the determined level of user expertise, then that can be done as desired and in any suitable manner. For example, the determined user expertise level could be used to select a specific, individual prompt to be provided to the user, or it could be (and indeed, as discussed herein, is preferably) used to select a set or group of prompts from which individual prompts to provide to a user will then be selected (whether also on the basis of the user expertise level or otherwise).

In a preferred embodiment, a user determined to have a low or lower level of expertise is preferably provided preferentially (and preferably only) with prompts relating to more basic operations and functionality of the user interface, device and/or device application(s). It is also similarly preferred for a user who has been determined to have a high or higher level of user expertise to be provided preferentially (and preferably only) with user prompts relating to more complex and advanced operations and functionality of the user interface, device and/or device application(s). It is also preferred for such more advanced users to no longer receive more basic user prompts (e.g. that may be provided to less “expert” users). This will avoid, for example, more advanced users being unnecessarily provided with user prompts for functions, etc., that they are already familiar with.

In a particularly preferred embodiment, the user prompts are graded into plural levels of relative complexity, and then the determined user expertise level used to select which complexity level of user prompts is to be used for the user at that time.

In a preferred such embodiment, the possible user prompts are sorted or classified into sets or groups depending on their relative complexity, and each such group of user prompts then associated with a corresponding user expertise level or range. The determined user expertise can then be used to select the set or group of user prompts to be used for the current user (i.e. from which the user prompts to provide to the user will be selected). In other words, for any given situation, there will be a matrix of possible prompts to provide to a user, based on the user's determined level of expertise. In such an arrangement, each set of user prompts preferably includes the same or a similar range of prompts, but the relative complexity of the prompts will vary between the sets.

Thus the method, device or apparatus of the present invention preferably stores or includes a means for storing a set or sets of user prompts that may be provided to a user in use.

In a particularly preferred embodiment, there are four identifiable levels of user prompt complexity and of user expertise (based, e.g., on an average interaction rating score, as discussed above), and the user prompts are selected according to which level of user expertise the user has obtained. Such levels could comprise, e.g., an “expert” level, an “okay” user level, a “beginner” level and a “user in trouble” level.

In such an arrangement, users having the lowest level of user expertise are preferably only provided with user prompts relating to generic or basic information about the device, user interface, and/or applications in question. At the next level up, prompts about more general usage may be provided. At the next (third) level, prompts about more advanced functionality may be provided, and, also, prompts about generic or basic information (i.e. the first (lowest) level prompts) are preferably removed (no longer provided) (second level, general usage, prompts could also be removed if desired). When a user obtains the highest level, the most complex user prompts and information can be introduced and provided. (As will be appreciated by those skilled in the art, this process would occur in reverse if, for whatever reason, a user's expertise level started to decrease.)

Thus, in a particularly preferred embodiment, a number of user expertise level threshold values or ranges are defined, and the current level of user expertise compared with those thresholds or ranges to determine the prompt or set of prompts to be used. The thresholds and ranges could, e.g., be fixed, or, e.g., be configurable and variable in use. They could also be (and indeed, preferably are) arranged to differ depending upon in which direction the user expertise level is moving (i.e. whether it is increasing or decreasing). This would allow the introduction of some hysteresis into the user expertise threshold changes, thereby, e.g., avoiding unnecessarily frequent changes of prompt sets around a threshold user expertise value. This would also help to avoid, e.g., a more expert user being reclassified as a less expert user, where the user is using the device in a noisy environment or attempting more complex interactions (both of which may lead to lower apparent expertise ratings, irrespective of the user's actual skill level).

Where the timing of user prompts is to be selected in response to the determined level of user expertise, then again that can be done in any desired and suitable manner. For example, again various levels or ranges of user expertise could be defined and associated with corresponding prompt frequencies and/or intervals.

In such arrangements, it is preferred for more expert users to receive prompts less frequently and vice-versa. Similarly, it is preferred for more expert users to be allowed a longer delay or interval between prompts and/or before a prompt is provided (and vice-versa).

As will be appreciated by those skilled in the art, the actual user prompt that is provided to a user in any given situation can and will typically be selected on the basis of more than just the determined level of user expertise. For example, it may depend on the device application that the user is currently using, the current functions or operations of the device, the current status of the device (e.g. whether it has only just been switched on), etc. Thus, typically, and, indeed, preferably, the user prompt is selected based on the determined level of user expertise and one or more other criteria, such as those outlined above. It would also be possible, for example, for only a limited set or selection of the possible user prompts of the device or its applications to be provided in accordance with the present invention, with other prompts being, e.g., provided and selected based on other criteria.

Indeed, as discussed above, in a particularly preferred embodiment, the determined user expertise is used to select a set of prompts to be used (and from which the actual prompt to be provided to the user will be selected), but the actual prompt itself is selected based on other criteria, such as the current context or situation of the application in question. In such a case, the method and apparatus of the present invention would include steps of or means for selecting a set of user prompts to be used based on the determined level of user expertise, and then selecting a user to prompt to use from that set of user prompts (whether based on the determined level of user expertise, other criteria, or a combination of the two, or otherwise).

It will also be appreciated that the timing of the provision of the user prompt or prompts can again be selected or determined by criteria in addition to (or instead of) the determined user expertise. For example, there may be one or more selected or predetermined criteria or conditions that trigger the automatic provision of a prompt to a user (and that, e.g., the system will monitor for and then provide a prompt in response to).

However, in an arrangement in accordance with the present invention, when user prompts are to be provided, the prompts that are provided or their timing should at least some of the time be in accordance with the user's determined level of user expertise.

The above operations and functions in accordance with the present invention, such as the determination of the user's level of expertise and the subsequent selection of the user prompts to provide, can be carried out in any appropriate unit or component and manner. For example, all the various described functions could be carried on the electronic device itself, for example by an application running on the device.

Equally, where the various user interface functions of the device are or may be distributed between the device and a communications system to which the device is coupled, then it would be possible for some or all of the various operations and functions in accordance with the present invention to be carried out on the distributed components of the system (and, e.g., accordingly not necessarily on the device itself). (As is known in the art, some components of a multimodal user interface, such as an automatic speech recognition engine, are typically implemented on the communications network infrastructure side (the server side) rather than on the terminal devices themselves (the client side). Such distributed functionality can also be used in the present invention).

Indeed, it is a preferred embodiment of the present invention for one or more of the functions relating to the present invention to be carried out on the communications network infrastructure (e.g. on a platform or server of the network) rather than on the device itself (i.e. the client side). Most preferably the user expertise measure determination calculation is carried out on a platform or server of or accessible via the communications system network, with the determined expertise level then, e.g., being posted back to the device (e.g. as an “event”).

Thus the system of the present invention could, e.g., be comprised on or as part of the device itself, or be a distributed arrangement across the device and other components external to the device (such as, e.g., a platform or server of or accessible via a communications network to which the electronic device can connect).

Where the device or system supports a multimodal interface and includes an “interaction engine”, then the determination of the user's level of expertise at least is preferably carried by the interaction engine. This is advantageous because the interaction engine may have better information about the user's interactions with the device, and also means that the user expertise determination can be carried out independently of the running of a device application and of the nature of a device application itself.

In one preferred embodiment, the user prompts, and the selection of which user prompt to provide, are provided and performed by a device application or applications. In this case, the or each device application preferably has a defined or predetermined set of user prompts that it then selects from accordingly. This is advantageous because typically the most appropriate prompt to provide to a user will depend on the application and the current use of the application (i.e. the prompts will be application specific). It may be easier therefore for the application itself to determine this. In this case, the interaction engine, for example, could provide its determined level of user expertise to the device application, with the device application then selecting a user prompt accordingly.

In another preferred arrangement, the application determines the set of prompts to select from (based on the determined level of user expertise), but the interaction engine selects the actual prompt to be used.

In a particularly preferred embodiment, the interaction engine also or instead stores a set or sets of user prompts that it can then select the user prompt to use from. In such an arrangement, it is preferred that the interaction engine provides and selects from a set of prompts that relate to more basic or generic functions (and that are, e.g., not application specific), as discussed above, and that may be provided to less expert users. Most preferably, the interaction engine stores and provides more basic prompts, and the applications then each store and provide sets of more complex prompts that are more application-specific.

In a particularly preferred embodiment, the various functions of the present invention, such as the user expertise determination, the sets of prompts that may be provided, and the prompt or prompt set selection process (e.g. the user expertise level thresholds at which a new prompt set is selected) can be varied in use in the device, for example by reprogramming or reconfiguring the device or system or parts of it (e.g. the interaction engine). Thus, for example, the user expertise determination is preferably provided in the form of an architecture “plug-in” for the interaction engine, such that it can, e.g., readily be changed or altered in use.

The various components described above and herein that comprise or form part of the present invention, or a device incorporating the present invention, such as, e.g., the interaction engine and/or speech recognition engine, may, as is known in the art, be provided as discrete, individual components, e.g., in the device itself. However, as will be appreciated by those skilled in the art, they may also be provided, e.g., as different “parts” of the same component (e.g. processing unit) or in a distributed form, on the device or elsewhere. It would also be possible, as is known in the art, and as discussed above, for components of the system or apparatus to be distributed across the overall (communications) system network, e.g. to be performed in part on the device itself and, e.g., also on, e.g. a server of, the communications network, etc., to which the device connects. For example, the user expertise determination and/or prompt selection may be distributed between a mobile device and a network server, with some of the tasks being performed on the mobile terminal (the client side) and some on a network server (the server side).

Although the present invention has been described above with particular reference to using the user expertise determined for a user to control the provision of prompts to a user of an electronic device, it is believed that a measure of the user's expertise could be used for other purposes as well. For example, the level of a user's expertise could be used to control the functionality of an application that a user is allowed to access and/or use, for example by hiding or omitting more complex functionality for less expert users. Such an arrangement could comprise, e.g., hiding the desired (selected) functions off-screen (e.g. such that they are not displayed and a user has to scroll to find them) for less expert users, but displaying such functionality for more expert users.

It is believed that such arrangements may be new and advantageous in their own right. Thus, according to a third aspect of the present invention, there is provided a method of operating an electronic device, the method comprising:

determining a level of user expertise of a user using the device; and

controlling an operation of the device on the basis of the determined level of user expertise of the user.

According to a fourth aspect of the present invention, there is provided a system for controlling the operation of an electronic device, comprising:

means for determining a level of user expertise of a user using the device; and

means for controlling an operation of the device on the basis of the determined level of user expertise of the user.

As will be appreciated by those skilled in the art, these aspects of the invention can and preferably do include any one or more or all of the preferred and optional features of the invention described herein, as appropriate. Thus, for example, the operation of the device that is controlled in accordance with the determined user's expertise preferably comprises the provision of prompts to a user of the device, and/or the provision of application functionality to a user of the device. Similarly, the user's expertise is preferably determined using one or more of the preferred techniques described herein.

It is also believed that the techniques for determining a measure of a user's expertise described herein may be new and advantageous in their own right. Thus, according to a fifth aspect of the present invention, there is provided a method of determining a measure of the expertise of a user using an electronic device, comprising:

monitoring the use of the user interface of the device, of an application running on or accessed via the device, and/or of the device, by the user; and

determining a level of expertise for the user based on that monitoring.

According to a sixth aspect of the present invention, there is provided a system for determining a measure of the expertise of a user using an electronic device, comprising:

means for monitoring the use of the user interface of the device, of an application running on or accessed via the device, and/or of the device, by the user; and

means for determining a level of expertise for the user based on that monitoring.

Again, and as will be appreciated by those skilled in the art, these aspects of the invention can and preferably do include any one or more or all of the preferred and optional features of the invention described herein, as appropriate. Thus, they, for example, preferably comprise one or more or all of the various preferred user expertise determination techniques described above, such as, for example, rating a set of the user's interactions and then using those ratings to determine the user's user expertise level. Similarly, a plurality of the user's interactions are preferably monitored and used when determining the level of the user's expertise.

It is envisaged that the present invention will have particular application to the voice interface of an electronic device (i.e. such that the user prompts that are selected in accordance with the present invention are spoken prompts and/or relate to the operation of the device or its applications via the voice interface). However, it can, as will be appreciated by those skilled in the art, also be applied to other forms of user interface, such as a screen or keypad, etc. It is in particular applicable to interfaces that permit more complex or varying levels of user input or interaction.

It is also envisaged that the present invention will have particular application to mobile or portable electronic devices, such as mobile ‘phones, PDAs, in-car systems, etc., i.e. in particular to devices that may have constrained user interfaces. However, it can, as will be appreciated by those skilled in the art, also be used for and applied to the user interfaces of other electronic devices, such as personal computers (whether desktop or laptop), and more general household appliances that include some form of electronic control, such as washing machines, cookers, etc. It is also envisaged that the present invention may have particular application to user interfaces for interactive television arrangements, e.g., where an interactive television arrangement is provided with and may be controlled by a multimodal user interface. The present invention is in particular applicable to any device capable of supporting a multimodal user interface. The present invention accordingly extends to an electronic device or system that can be operated in accordance with or that includes the methods or apparatus of the present invention.

As will be appreciated by those skilled in the art, all of the above aspects and embodiments of the invention may include any one or more or all of the preferred and optional features of the invention described herein, as appropriate.

The methods in accordance with the present invention may be implemented at least partially using software e.g. computer programs. It will thus be seen that when viewed from further aspects the present invention provides computer software specifically adapted to carry out the methods herein described when installed on data processing means, a computer program element comprising computer software code portions for performing the methods herein described when the program element is run on data processing means, and a computer program comprising code means adapted to perform all the steps of a method or of the methods herein described when the program is run on a data processing system. The invention also extends to a computer software carrier comprising such software which when used to operate an electronic device or system comprising data processing means causes in conjunction with said data processing means said device or system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of preferred embodiments of the present invention will now be described by way of example only and with reference to the accompanying drawings, in which:

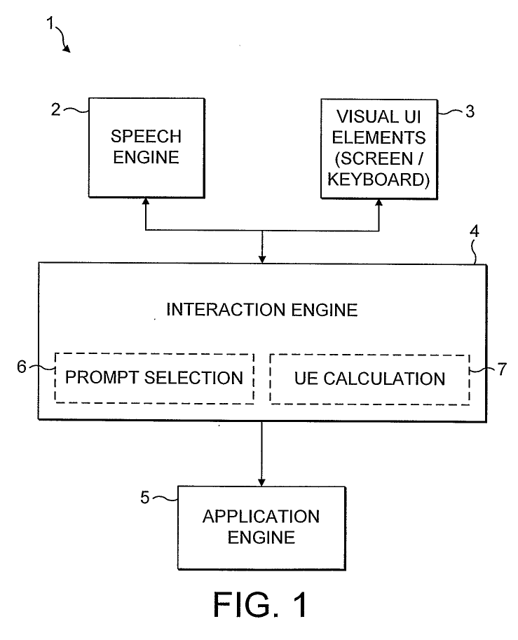

FIG. 1 shows schematically a mobile device that may be operated in accordance with the present invention; and

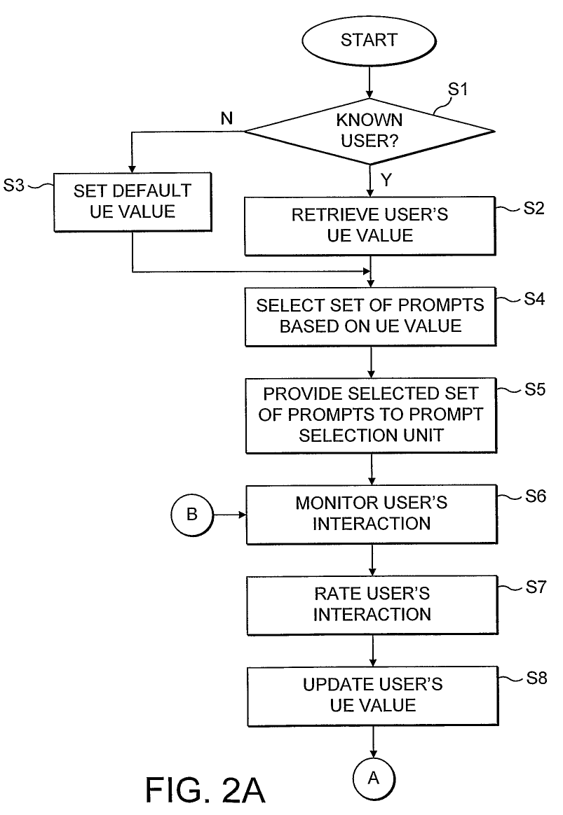

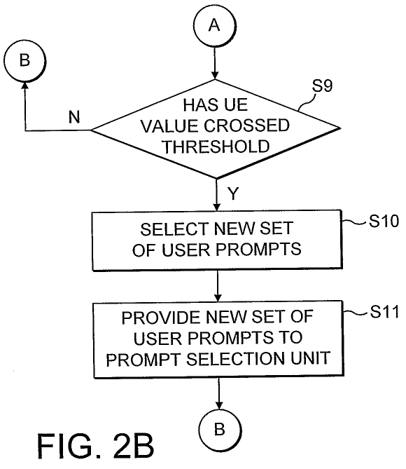

FIGS. 2A and 2B show schematically the operation of the mobile device of FIG. 1.

FIG. 1 shows schematically a mobile device 1 in the form of a mobile telephone that includes a multimodal user interface arranged to operate in accordance with the present invention. In the mobile telephone shown in FIG. 1, the user interface has three interaction modes, namely a keypad, a screen, and the ability to recognise speech commands and to speak synthesised text (e.g. to provide speech prompts and information to a user).

As shown in FIG. 1, the mobile telephone 1 includes, inter alia, a speech engine 2, visual user interface (UI) elements 3 (which in the present embodiment are in the form of screen and keyboard), an interaction engine 4 and an application engine 5. The mobile telephone will, of course, include other components that are not shown, such as a radio transmitter and receiver, etc., as is known in the art.

The interaction engine 4 synchronises the control of the user interface elements of the telephone 1 and coordinates the operation of the user interface and the applications running in the application engine 5, as is known in the art. For example, it will monitor speech recognition events on the speech engine 2, and respond appropriately to those events, for example by controlling the visual user interface elements 3 to provide a particular display on the screen. Similarly, the interaction engine 4 also responds to keyboard events via the visual user interface 3 and again, e.g., will control the visual user interface element 3 to change the screen display, and/or control the speech engine 2 to provide an appropriate text to speech prompt.

In order to do this, the visual user interface elements 3 for example, post and receive events from the interaction engine 4. For example, they may receive commands from the interaction engine 4 to display particular information on the screen, and/or provide to the interaction engine information detailing text that a user has typed on the keyboard.

Similarly, the speech engine 2 and the interaction engine 4 operate to provide a speech-enabled interface of the mobile telephone 1. In particular, the interaction engine 4 can control the speech engine 2 to provide text to speech prompts to a user, and can send recognition activation requests to the speech engine 2 when it wishes to determine whether a speech command has been attempted by a user. The speech engine 2 acts to post speech recognition events (whether positive or negative) to the interaction engine 4, as is known in the art, for the interaction engine then to process further.

As shown schematically in FIG. 1, in this embodiment, the interaction engine also includes a prompt selection module 6 and a user expertise (UE) calculation module 7 that will perform the user expertise calculation and subsequent prompt selection in the telephone 1 in a manner in accordance with the present invention, as will be explained further below.

The application engine 5 runs the applications of the telephone 1 that, e.g., a user may wish to use or access. In this embodiment, an application running on the application engine 5 can initiate user interface changes or update the user interface when the application is running. It does this by providing appropriate command instructions to the interaction engine 4, which then controls the speech engine 2 and/or visual user interface elements 3 accordingly. Thus the application engine 5 can, for example, provide to the interaction engine 4 commands and data to activate application user interface events, such as activating voice dialogues, loading prompt sets, activating visual menus, and getting user interface inputs, etc. In this embodiment, the application engine 5 can also retrieve the user expertise level determined by the interaction engine 4 to allow it to then select the set of prompts to be provided to the prompt selection module 6 of the interaction engine 4 (which prompt selection module 6 will then select one of the prompts from the set for providing to the user, as appropriate (as will be discussed further below)).

In this embodiment, the interaction engine 4 stores a number of sets of user prompts, each having different relative complexity, that may be provided to a user in use. These prompts relate to more generic or basic functions of the device, and that are not application specific or dependent. Examples of such prompts include prompts related to the user interaction process, such as, for example, “push the green key to talk”, “press F1 for help”, etc., prompts to provide help and tips during the user interaction process (e.g. when problems are detected), such as, for example, “speak naturally”, “speak when shown on the screen”, “speak correct sentences”, “press the red key to disable speech output”, etc.

The application engine 5 also stores sets of prompts associated with applications that it is running or can access. These sets of prompts include prompts that are more application dependent or specific (i.e. that are to do with the application that they are associated with). The prompts that are stored are specific to the application in question, but the set or sets of prompts for each application follows the same basic usage or configuration pattern.

An example of these prompts would be, where, e.g., the user is in an operator service menu application (i.e. an application to provide access to operator menus), “welcome” prompts (such as “welcome to Vodafone live portal”), a generic application usage instruction (such as “ask for the service you are looking for and navigate the menu using the keyboard”), an instruction or tip regarding application functionality (such as, e.g., “check the alert sections for getting sport alerts”), “form filling” tips for forms that are currently, e.g., visually active (such as “select or say the name of the horoscope you would like to check”), prompts relating to detected interaction problems within an application context (such as, for example, “I can't understand you. For example, to check your horoscope say ‘go to horoscope’”), or a combination of these, such as a “welcome” and a “tip” prompt (such as, e.g., “welcome to horoscopes, say or enter the name of the horoscope you would like to check, and remember, you can access your horoscope directly by saying for example: ‘go to Sagittarius horoscope’”).

For a 3D space game, a “welcome” prompt might be “hi, this is the onboard computer talking”, a generic application usage instruction might be “push the green key to talk”, and a tip for application functionality might be “radar reports enemies approaching, for detailed report ask for radar report”, and so on.

As will be explained further below, these various stored sets of prompts are selectively loaded into the prompt selection module 6 of the interaction engine 4, which prompt selection module 6 then selects one of the prompts in the set to provide to a user.

It should be noted here that FIG. 1 simply shows schematically the logical layout of some of the components of the mobile telephone 1. As will be appreciated by those skilled in the art, the actual software and/or hardware components comprising the architecture of the mobile telephone 1 may be structured differently, and, indeed, in any appropriate manner. Furthermore, some of the components shown in FIG. 1 may be distributed across the telephone and/or across the network in which the telephone operates. For example, it is known to distribute speech recognition engines such that some of the tasks are performed on a terminal device and some tasks on a server on the communications network. The other user interface modes and the user expertise functions could also be distributed in a similar manner. The mobile telephone of the present embodiment could accordingly be arranged in this manner, if desired.

It should also be noted that not all of the applications, or indeed of the mobile telephone's 1 functions, need be provided with multimodal user interface functionality (and, in particular, with the speech-enabled interface). For example, a single one or a selected one of the applications running on the application engine 5 could have multimodal functionality, with the remaining applications and the telephone 1 as a whole simply being operated via the visual user interface elements 3. Of course, it would also be possible for all applications and the telephone as a whole to be operable by the multimodal interface, if desired.

In operation of the mobile telephone 1 shown in FIG. 1, the interaction engine 4 monitors the use of the device 1 and applications running on the application engine 5 by a user, and provides information regarding those interactions to the user expertise calculation module 7. The user expertise calculation module 7 then uses that information to determine a current level of expertise of the user of the device. The interaction engine 4 then uses this determined level of user expertise to determine whether it should provide the set of prompts to be used for the current user, or whether an application specific set of prompts should be provided. In the latter case, interaction engine 4 provides the determined level of user expertise to the application engine 5, which then uses the determined level of user expertise to select a set of stored prompts for the application that is currently being used by the user that corresponds to the determined level of user expertise (as will be explained further below). The application engine 5 then returns the selected set of prompts to the prompt selection module 6 of the interaction engine 4.

Once it has received the determined set of prompts (whether from the interaction engine 4 or application engine 5), the prompt selection engine 6 selects a prompt from the provided set of prompts, for example, based on the current status of the application or the user's interaction, which prompt is then provided by the interaction engine 4 via the speech engine 2 or visual user interface elements 3 automatically to the user.

(Other arrangements would, of course, be possible. For example, the user expertise calculation and/or prompt selection could, for example, be carried out in the application engine 5, rather than in the interaction engine 4.)

In order to calculate the level of user expertise, the user expertise calculation module 7 of the interaction engine 4 rates each user interaction that the telephone 1 receives by allocating a points value or score to each user interaction, and then calculates a moving average of the scores of the last five user interactions. The average value is then used as a measure of the user's current level of expertise.

In this embodiment, the interaction engine 4 of the mobile telephone stores a user's current level of expertise for future use (e.g. after a user has finished using the telephone 1) (although this is not essential). This is stored in association with, for example, an authentication code or password, or biometric user verification data, such as a voiceprint or fingerprint, that can be used to recognise the user in question. This avoids a user returning to a low level of expertise when they next use the mobile telephone.

In the present embodiment, user interactions are rated (i.e. allocated a points score) as follows:
1. If the user speaks something and this is not recognised, a score of zero points is allocated to that user interaction.
2. When the user uses the keyboard to interact with the mobile telephone, a rating of 40 points is allocated for that user interaction.
3. When the user speaks a simple voice command, such as, for example, “go to games”, that user interaction is allocated a score of 60 points.
4. When the user speaks a complex voice command (such as filling a form or one including a plurality of (recognised) parameters), that user interaction is allocated 60 points plus 10 points per recognised parameter from within the command (for example, in a travel booking application, if the user says: “I want to go to London, next Thursday arriving at Heathrow Airport”, then that user interaction would be given a rating of 90 points, since the spoken command is advanced and uses three recognised parameters).

Other arrangements would, of course, be possible. For example, the above criteria and ratings for user interactions could be varied. Also, the ratings, etc., could, for example, be configured in accordance with and/or by the application running on the device itself.

It would also be possible to use other metrics for determining the user expertise, either as an alternative to the above criteria or in addition to the above criteria. For example, the average time taken in between user interactions, the confidence value returned from the speech recognition engine of the mobile telephone when processing speech commands, a waveform analysis of the user's spoken commands, and/or the keyboard usage patterns, etc., could also or instead be used when determining the level of user expertise. It would also, e.g., be possible to use an, e.g., weighted, combination of a number of such metrics.

When a user first uses the mobile telephone, it is first determined whether there is a stored user expertise level for the user in question. If there is, then the current user expertise is set to that level.

On the other hand, if a stored user expertise level is not available, then the user expertise level is set to a predetermined default value until a selected number of user interactions have occurred and been rated (for example five user interactions in the present embodiment). This default value may, e.g., be based on a profile determined or provided for the user. However, in the present embodiment, a predetermined default user expertise value of −1 is used whenever a stored user expertise value is unavailable. (The provision of a default user expertise value in this way allows the system to, in particular, be capable of handling unknown users with unknown levels of user expertise.)

Thereafter, whilst a user is using the mobile telephone, the moving average of the last five (or any other desired number) of interaction rating results is determined as the user's current level of expertise as discussed above, and then used to select the set of prompts from which a prompt to be provided to the user is selected.

An example of this process will now be described in more detail, considering the situation of an “unknown” user who first uses the telephone 1.

As discussed above, when an “unknown” user first uses the telephone, the user will be accorded a default user expertise rating of −1. In response to this user expertise rating, the interaction engine 4 selects one of its own stored sets of user prompts that provide generic information only, such as, for example, “use the green key”, for providing to the prompt selection module 6 (on the assumption that the user will be unfamiliar with the user interface). These prompts may also, e.g., be arranged to encourage the user to start using the (e.g. speech-enabled) interface.

As the user starts to use the mobile telephone, then his or her expertise level will start to tend towards zero. Once an average of zero (or, e.g., a little above zero, such as in the range 0-3) has been reached, the interaction engine 4 is configured to then provide a set of user prompts about general usage of the device and application, such as, for example, “you must speak naturally”, “press and hold the green key”, “ensure that you speak when prompted on the screen”, etc., to the prompt selection module 6. Examples of user prompts such as, for example “you can say, for instance: go to games”, could also be provided. This may help to speed up the user learning curve.

Once the user starts to enter successful speech commands and get used to the logic of the user interface and how menus shown on the screen can be matched to speech commands, for example, then the user will receive user expertise ratings of, for example, 60 points for simple voice commands and 40 points for keyboard commands. At this point the user's average level of expertise will tend to the range between 40 and 60 points.

At this stage, the interaction engine 4 is arranged to identify that applications specific user prompts about more advanced functionality are required and, also, that prompts for inexperienced users (i.e. the prompts that are provided for user expertise averages of −1 and zero) can be removed, as users whose rating is in this range can be considered to be starting to succeed in using the device and application via the voice interface.

The interaction engine 4 accordingly provides the determined user expertise level to the application engine 5, which then uses that level to select a set of application specific prompts that it then provides to the prompt selection unit 6.

Such set of application prompts, for example, in the context of a 3D game when a spaceship takes off could comprise, e.g., “the onboard computer is ready”, “computer ready, speak commands as required”, and “computer ready, hold the green key to talk”. This would provide a relatively “non-expert” set of applications specific prompts.

As a user becomes familiar with the telephone's more advanced voice functionality, then the user's moving average expertise rating will exceed 60. At this point, the most complex user prompts and information can be provided to the user.

Accordingly, the interaction engine 4 will again provide the determined user expertise level to the application engine 5, which will then select a more complex set of applications specific prompts for providing to the prompt selection unit 6. It is also preferred at this stage to provide shorter prompts. This may, e.g., help a user to feel more comfortable, provide better privacy, and/or allow a user to focus better on learning other functionalities of the device.

Again considering the above example of a 3D game when a spaceship is to take off, then such an “expert” set of application specific prompts could comprise, e.g., “onboard computer ready”, “ready”, and “I am ready”.

As discussed above, the prompt selection unit 6 of the interaction engine 4 selects a prompt to provide to the user in any given situation from the set of prompts that it is provided with on the basis of the user expertise determination. The selection of the actual prompt to be used by the prompt selection unit 6 can be carried out on any appropriate basis, for example, in accordance with the current context and situation of the application that the user is accessing.

FIGS. 2A and 2B show schematically this operation of the present embodiment.

As shown in FIG. 2A, at the start of the process, it is first determined in step S1 whether the user is a user previously known to the system. If so, the user's expertise value is retrieved in step S2. If not, the user's expertise value is set to the default user expertise value in step S3. The user expertise value is then used in step S4 to select a set of prompts to be used, which set of prompts is then provided to the prompt selection unit 6 in step S5.

The system then monitors the user's next interaction in step S6 and rates that interaction in step S7. The user expertise value is then updated in step S8. It is then determined (in step S9) whether the user's user expertise value has crossed a user expertise value threshold. If not, the system returns to step S6 and continues to monitor the user's interactions and update the user's user expertise value accordingly.

If in step S9 it is determined that the user expertise value has crossed a user expertise threshold, then a new set of user prompts is selected in step S10 and provided to the prompt selection unit 6 in step S11. The system then returns again to continue monitoring the user's interactions at step S6.

As will be appreciated by those skilled in the art, the above user expertise level ranges and thresholds are not essential, and other thresholds and arrangements could be used. It would also be possible for the thresholds and ranges to be varied in use, if desired. Similarly it would also be possible for the above exemplary user expertise determination and prompt selection processes of the present embodiment to be varied as desired, and, for example, to configured or changed in use. This could all be done, e.g., by reprogramming or reconfiguring the interaction engine 4.

It should also be noted here that the above thresholds and ranges also apply should the current level of user expertise decrease as well as increase. Thus, for example, if the average determined user expertise rating falls below a given threshold, then a change in the set of prompts that is provided to the prompt selection module 6 will be triggered and the new set of user prompts determined. It would also be possible, e.g., to vary the thresholds in dependence upon in which direction the user expertise rating is moving (i.e. whether it is increasing or decreasing), i.e. for there to be an element of hysteresis introduced into the threshold crossings. This would help to avoid, e.g., undesirably frequent changes of user prompt sets where a user's expertise level varies around one of the thresholds.

Enhancements to the system of the present embodiment (and indeed of the present invention) would be possible. For example, the system could also be used to identify user interaction problems, which problems could, e.g., tracked and stored for use to, e.g., later contact users for a tutorial or training course.

Such user interaction problems could, e.g., be recognised when a user reaches a low user expertise rating (e.g. zero), and/or when after retrying several times, the user expertise level does not improve. In such a case, the system could respond by, e.g., sending a network signal or message, such as a short data message (e.g. SMS message) such as “I need help with xxxx application”, to, e.g., a customer services facility of the mobile phone service provider. The service provider could then respond appropriately, e.g., by having customer services make a courtesy call to the mobile device in question.

The request for assistance could also, e.g., be provided by an application that the device is accessing (particularly if the application is a connected application, i.e. one that operates on the server side as well as the device side), and/or could be provided by the interaction engine where the interaction engine is distributed across the network.

As will be appreciated by those skilled in the art, classification of functionality and commands, etc., as being “simple” or “complex” will be dependent upon the particular circumstances, and, for example, the nature of the application that the user is currently using. For example, commands that take multiple parameters by using a natural language sentence may be classified as being more complex. Similarly, “go to games”, for example, may be considered to be a more simple voice short-cut in a multimodal service menus application, while “subscribe to Sagittarius horoscope via MMS” could be considered to be a more complex command.

In a preferred arrangement, sets of prompts are grouped by and/or labelled with a particular tag or name for the corresponding selected level of user expertise, such as “expert”, “beginner”, “okay”, “user in trouble”, etc. This would allow, e.g., the authoring content, etc., to include the prompts with appropriate mark-ups for the purpose, and/or facilitate searching content for the appropriate prompts.

It would also be possible to use the determined level of user expertise to control other functions or operations of the device, such as the timing of prompts and/or the functions of an application that a user is shown and/or allowed to access, as discussed above.

Although the present embodiment has been described above with reference to the voice interface of a mobile telephone, it can, as will be appreciated by those skilled in the art, also be applied to other forms of user interface, such as a screen or keypad, etc.

Similarly, the present invention is applicable to more than just mobile ‘phones, and may, e.g., be applied to other to mobile or portable electronic devices, such as mobile radios, PDAs, in-car systems, etc., and to the user interfaces of other electronic devices, such as personal computers (whether desktop or laptop), interactive televisions, and more general household appliances that include some form of electronic control, such as washing machines, cookers, etc.

As can be seen from the above, and as will be appreciated by those skilled in the art, the present invention, in its preferred embodiments at least, provides a user interface that can be tailored to only provide information that is relevant to the current user and user interaction. This allows, for example, the user interface to be arranged such that the user will initially be provided with prompts relating to more simple commands and functionality of the user interface, but then once the user is familiar with those commands and functions, allow the user to progress to more complex commands and functions, but not before. In this way, users can, for example, be helped to use the system basics very quickly, and only after that will they start getting instructions and prompts about how to use more complex functionality. The interface can also be arranged so that it no longer provides to a user prompts relating to commands and functions that the user is already familiar with.

The present invention, in its preferred embodiments at least, also facilitates the simplification of applications running on a device, and the making of such applications capable of dealing efficiently with users having different levels of expertise, while still taking account of user interface limitations of a device.

This is achieved by tracking and taking account of the user's expertise in using the device or application, and then selecting and tailoring the information and user prompts provided to the user accordingly. In this way, the user interface is tailored to the current level of expertise and familiarity of the user, and avoids, e.g., attempting to provide too much information at the same time, and/or being too repetitive.

1. A method of operating a user interface of an electronic device, which interface may provide a plurality of prompts to a user, the method comprising:
determining a level of user expertise of a user using the device; and
providing a prompt to the user on the basis of the determined level of user expertise of the user.

2. The method of claim 1, wherein the user prompts comprise information relating to at least one of: functions or operation of applications that may be run on the device; functions or operations of the device itself; and functions or operation of the device's user interface.

3. (canceled)

4. The method of claim 1, wherein the step of providing the prompt to the user on the basis of the determined level of user expertise further comprises controlling the timing of the provision of a prompt to the user based on the determined level of user expertise of the user.

5. The method of claim 1, wherein at least one set of user prompts can be provided, and the determined user expertise level is used to select which of the sets of prompts is to be used.

6-8. (canceled)

9. The method of claim 1, wherein a number of user expertise level threshold values or ranges are defined, and a determined current level of user expertise is compared with those thresholds or ranges to determine a prompt or set of prompts to be used.

10. The method of claim 1, comprising monitoring the use of at least one of: the user interface of the device; of an application running on or accessed via the device; and of the device, by the user, and
determining a level of expertise for the user based on that monitoring.

11-12. (canceled)

13. The method of claim 1, comprising rating each of a plurality of user interactions of a user with at least one of the user interface of the device; the device; and an application, and
determining the level of user expertise using the ratings of a selected number of user interactions in combination.

14. The method of claim 1, comprising using a measure of a time taken between user interactions when determining the level of user expertise.

15. The method of claim 1, comprising using a confidence value determined by a speech recognition engine as at least a part of the determination of the level of user expertise.

16. The method of claim 1, comprising storing a current level of expertise of a given user for use when the user next uses the device.

17. The method of claim 1, wherein a user is allocated a predetermined default user expertise level.

18. The method of claim 1, comprising selecting a set of user prompts to be used based on the determined level of user expertise, and selecting a user prompt to use from the set of user prompts.

19-21. (canceled)

22. The method of claim 1, wherein the steps of the method are distributed between the device and at least one component of a communications system infrastructure accessible via the device.

23. A system for providing a user interface for an electronic device, comprising:
a processor for determining a level of user expertise of a user using the device; and
a processor for providing a prompt to a user of the device on the basis of the determined level of user expertise of the user.

24. (canceled)

25. The system of claim 23, comprising a processor for controlling a timing of the provision of a prompt to the user based on the determined level of user expertise of the user.

26. (canceled)

27. The system of claim 23, wherein a number of user expertise level threshold values or ranges are defined, and further comprising a processor for comparing a determined current level of user expertise with those thresholds or ranges to determine at least one prompt to be used, whereby the processor for comparing may be the processor for providing.

28. The system of claim 23, comprising a processor for monitoring the use of at least one of: the user interface of the device; of an application running on or accessed via the device; and of the device, by the user, and
a processor for determining a level of expertise for the user based on that monitoring.

29-30. (canceled)

31. The system of any claim 23, comprising a processor for rating each user interaction of a user with at least one of: the user interface of the device; the device; and an application, and
a processor for determining the level of user expertise using the ratings of a selected number of user interactions in combination.

32. The system of claim 23, comprising a processor for using a measure of time taken between user interactions when determining the level of user expertise.

33. The system of an claim 23, comprising a processor for using a confidence value determined by a speech recognition engine as at least part of the determination of the level of user expertise.

34. The system of claim 23, comprising a processor for storing a current level of expertise of a given user for use when the user next uses the device.

35. The system of claim 23, comprising a processor for allocating a user a predetermined default user expertise level.

36. The system of claim 23, comprising a processor for selecting a set of user prompts to be used based on the determined level of user expertise, and a processor for then selecting a user prompt to use from the set of user prompts.

37-39. (canceled)

40. A communications system that includes the system of claim 23.

41. A computer program product comprising computer software code embodied on a computer readable medium for performing the method of claim 1 when the program code is run on a processor.

42-46. (canceled)
